(19) United States
(12) Patent Application Publication
(10) Pub. No.: US 2014/0291125 A1
(43) Pub. Date: Oct. 2, 2014

(54) Roller for Transporting Glass Substrate and Transporting Device Thereof

(71) Applicant: Shenzhen China Star Optoelectronics Technology Co., Ltd., Shenzhen, Guangdong (CN)

(72) Inventor: Binglong Li, Shenzhen City (CN)

(73) Assignee: Shenzhen China Star Optoelectronics Technology Co., Ltd., Shenzhen, Guangdong (CN)

(21) Appl. No.: 13/979,666

(22) PCT Filed: Jun. 21, 2013
(86) PCT No.: PCT/CN2013/077673

§ 371 Date: Jul. 15, 2013

(30) Foreign Application Priority Data
Mar. 26, 2013 (CN) 201310100770.9

(51) Int. Cl. B65G 13/04; B65G 39/02

(52) U.S. Cl. CPC B65G 13/04; B65G 39/02
USPC 198/780

(57) ABSTRACT

The present invention provides a roller for transporting glass substrate and a transporting device thereof. Wherein, the roller comprises: a cylindrical body and an outside layer coated on the side of the cylindrical body. The distance between the top and the bottom of the cylindrical body is 100˜120 mm, the cylindrical body is made of MC nylon, and the outside layer is polyurethane coating. In the roller and the transporting device of the transporting glass substrate according to the present invention, the roller is widened, which is made of the material with better buffering performance. When it is used for transporting the glass substrate, the contact area between the roller and the glass substrate will be increased. And the distance between the rollers is decreased, so that the glass substrate will be transported steadily with average stress, and the structural damage of the substrate will be decreased, which avoids the mura problems and improves the level and quality of the glass substrate.

This application claims priority to Chinese Patent Application Serial No. 201310100770.9, named as “roller for transporting glass substrate and transporting device thereof”, filed on Mar. 26, 2013, the specification of which is incorporated herein by reference.

### BACKGROUND OF THE INVENTION

1. Field of the Invention

The present invention relates to the field of image display, and in particular to a roller for transporting glass substrate and a transporting device thereof.

2. The Related Arts

Currently, in LCD industry, there are many transporting method for glass substrate, especially roller type conveyor is the most common.

In different process sections, utilize different transporting method to deal with various purposes and requirements. For example, the roller type conveyor used in the backend of high vertical alignment (HVA) process utilizes the roller made of ultrahigh molecular weight polyethylene (UHMW-PE) with 10 mm width, which has good properties of wear resistance, self-lubrication and insulation.

As shown in FIG. 1, the width D of the rollers according to the present technology is usually 10 mm, and the spacing between the rollers is 190˜245 mm, which design is simple and portable. However, because the width of the roller is small, the contact area between the glass substrate and the roller during transportation is also small, which is almost line contact. Furthermore, the spacing between the rollers is larger so that the stress occurred on the high-generation glass substrate during transportation concentrates on the several contact line between the glass substrate and the roller, which results in mura symptom on the glass substrate. Therefore, the quality of the glass substrate is injured seriously, which may even cause the entire glass substrate scrapped.

### SUMMARY OF THE INVENTION

The technical issue to be solved by the present invention is to provide a roller for transporting glass substrate and a transporting device thereof, which efficiently decreases the damages occurred during transportation of the glass substrate.

In order to solve the technical issue, the embodiment according to the present invention provides a roller for transporting glass substrate, comprising: a cylindrical body and an outside layer coated on the side of the cylindrical body, the distance between the top and the bottom of the cylindrical body being 100˜120 mm, the cylindrical body being made of MC nylon, and the outside layer being polyurethane coating.

Wherein, the axle of the cylindrical body is provided with an axle hole defined through the top and the bottom.

Wherein, the thickness of the polyurethane coating is 5 mm.

The present invention further provides a transporting device of glass substrate, which comprises: at least two rotating shafts provided in parallel with an interval, each rotating shaft coaxially providing with two rollers, the roller further comprising: a cylindrical body and an outside layer coated on the side of the cylindrical body, the distance between the top and the bottom of the cylindrical body being 100˜120 mm, the cylindrical body being made of MC nylon, the outside layer being polyurethane coating; and a liftable platform provided below the rotating shaft and the roller.

Wherein, the axle of the cylindrical body is provided with an axle hole defined through the top and the bottom.

Wherein, the rotating shaft passes through the axle hole and is assembled with the roller through a set collar.

Wherein, the interval between the rollers on the same rotating shaft is 25˜150 mm.

Wherein, the liftable platform comprises multiple supporting rods which are provided at the interspace between the rotating shafts and between the rollers.

Wherein, the multiple supporting rods are divided into multiple groups, the supporting rods of each group are provided between the adjacent rotating shafts, and the supporting rods of the same group are aligned with each other and arranged in a line.

Wherein, the thickness of the polyurethane coating is 5 mm.

The present invention further provides a transporting device of glass substrate, which comprises: at least two rotating shafts provided in parallel with an interval, each rotating shaft coaxially providing with two rollers, the interval between the rollers on the same rotating shaft being 25˜150 mm, the roller further comprising: a cylindrical body and an outside layer coated on the side of the cylindrical body, the distance between the top and the bottom of the cylindrical body being 100˜120 mm, the cylindrical body being made of MC nylon, the outside layer being polyurethane coating; and a liftable platform provided below the rotating shaft and the roller.

In the roller and the transporting device of the transporting glass substrate according to the present invention, the roller is widened, which is made of the material with better buffering performance. When it is used for transporting the glass substrate, the contact area between the roller and the glass substrate will be increased. And the distance between the rollers is decreased, so that the glass substrate will be transported steadily with average stress, and the structural damage of the substrate will be decreased, which avoids the mura problems and improves the level and quality of the glass substrate.

### BRIEF DESCRIPTION OF THE DRAWINGS

To illustrate clearly the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic view illustrating a roller according to the present technology;

FIG. 2 is a schematic perspective view illustrating a roller used for transporting glass substrate according to the first embodiment of the present invention;

FIG. 3 is a sectional side view illustrating a roller used for transporting glass substrate according to the first embodiment of the present invention;

FIG. 4 is a schematic top view illustrating a transporting device of glass substrate according to the second embodiment of the present invention; and

FIG. 5 is a schematic side view illustrating a transporting device of glass substrate according to the second embodiment of the present invention.

### DETAILED DESCRIPTION OF THE PREFERRED EMBODIMENTS

The accompanying drawings and the following detailed descriptions are the preferred embodiments of the present invention.

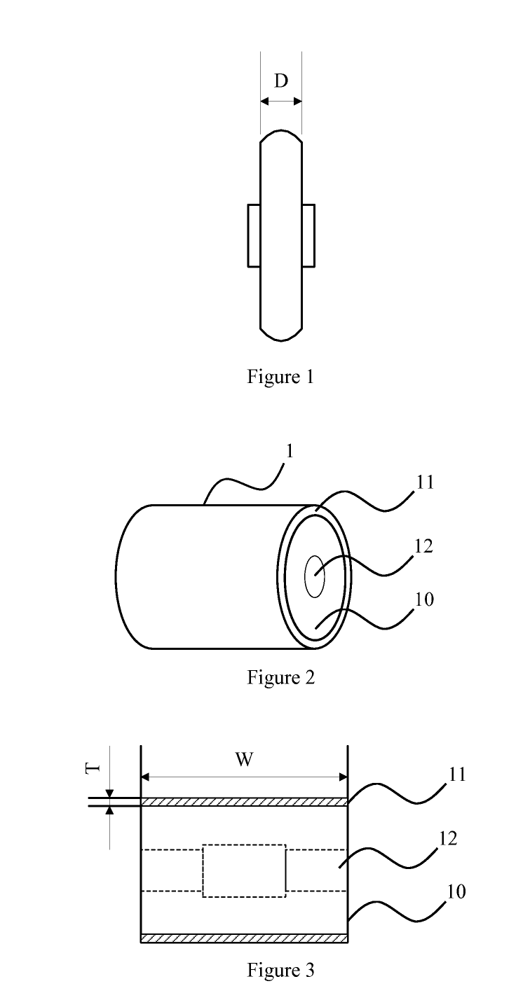

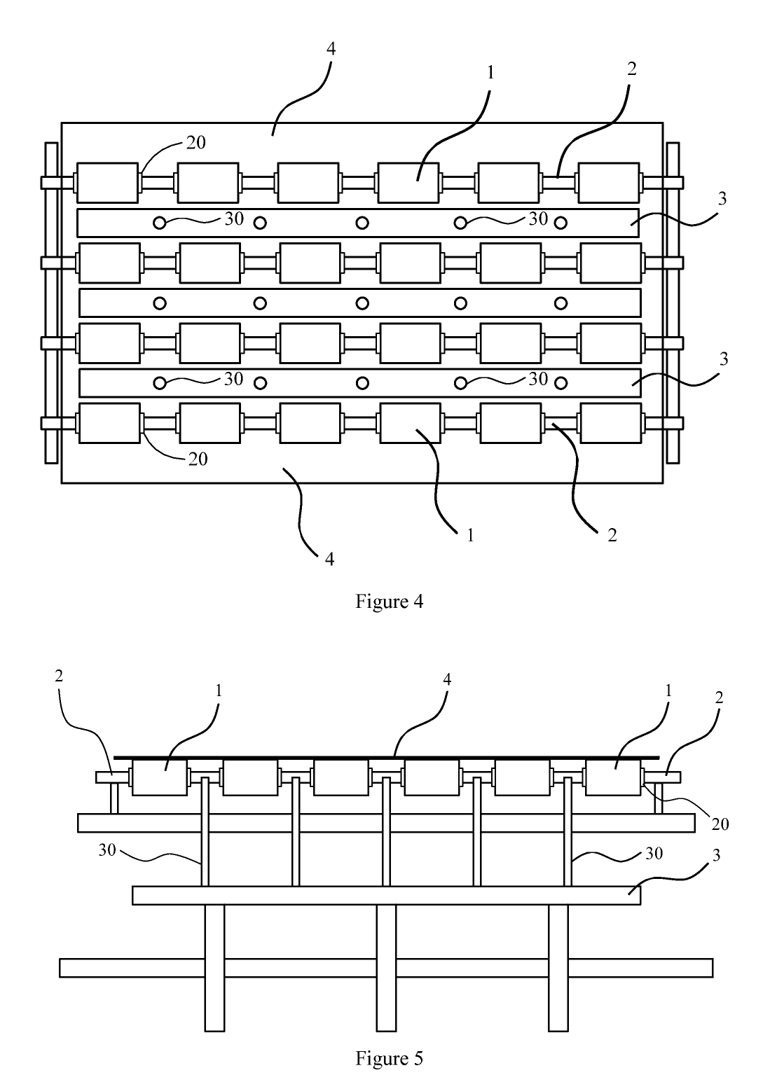

Referring to FIG. 2, the present invention provides a roller 1 used for transporting glass substrate, which comprises a cylindrical body 10 and an outside layer 11 coated on the side of the cylindrical body 10. The axle of the cylindrical body 10 is provided with an axle hole 12 defined through the top and the bottom, which is used to be assembled with a rotating shaft 2 (as shown in FIG. 4).

In the present invention, the width of the roller 1 is widened to 100˜120 mm. It should be noted that the body 10 of the roller 1 is cylindrical and the width of the roller 1 according to the present embodiment refers to the distance between the top and the bottom of the body 10, that is, the side length W of the cylinder as shown in FIG. 3. FIG. 3 is a sectional side view illustrating the roller 1. In the present invention, W is 100 mm, and the thickness T of polyurethane coating is 5 mm. In the present embodiment, the width W of the roller 1 is selected based on several factors: first, the width of the roller according to the present technology is only 10 mm, indicating that the contact area between the glass substrate and the roller during transportation is smaller, so the embodiment needs to widen the width of the roller 1 (W>10 mm); second, the size of the transported glass substrate is usually 2200×2500 mm, so W<200 mm; third, the roller is not as widely as possible, if the roller is too wide, the total weight of the transporting device of glass substrate will be increased, which may increase the driving load; therefore, after practical test, the width W of the roller 1 is suitable in the range of 100˜120 mm.

The body 10 is made of MC nylon. MC nylon has good properties of wear resistance, self-lubricating, low noise, and good mechanical properties. The outside layer 11 is polyurethane coating. Polyurethane has high mechanical strength, excellent wear resistance and compression resistance. The roller 1 made of new materials has good properties of anti-shock and buffer performance.

The roller according to the first embodiment of the present invention is used for transporting glass substrate. Accordingly, the second embodiment of the present invention provides a transporting device of glass substrate, as shown in FIG. 4, which comprises at least two rotating shafts 2 provided in parallel with an interval, each rotating shaft 2 coaxially providing with two rollers 1, specifically, the rotating shaft 2 passing through the axle hole 12 and assembled with the roller 1 through a set collar 20; and a liftable platform 3 provided below the rotating shaft 2 and the roller 1. Wherein, the structure and the material of the roller 1 are the same as the first embodiment, and not repeat here. To ensure successfully transporting the glass substrate 4, the apex of each roller 1 should be in the same plane, and the glass substrate 4 is transported on the plane.

Accompanying with FIG. 5, the liftable platform 3 comprises multiple supporting rods 30. When the upstream robot places glass substrate 4, the liftable platform 3 rises, the supporting rods 30 prop up the glass substrate 4, and then the liftable platform 3 descends, the glass substrate 4 is placed on the roller to transportation; when the glass substrate 4 is transported to the downstream, the liftable platform 3 rises, the supporting rods 30 prop up the glass substrate 4, and then the downstream robot takes off the glass substrate 4. Because the roller 1 according to the present embodiment is widened to 100˜120 mm, the supporting rods 30 should be provided at the interspace between the rotating shafts and between the rollers in order to avoid the interference between the roller 1 and he supporting rods 30 occurred during the lifting process of the liftable platform 3. Preferably, the supporting rods 30 are divided into multiple groups, each group is provided between the adjacent rotating shafts 2, and the supporting rods 30 of the same group are aligned with each other and arranged in a line.

Furthermore, in order to overcome the problems of stress concentration resulted from larger interval between the rollers on the same rotating shaft, the interval between the rollers on the same rotating shaft is decreased in the present embodiment. At the same time, the roller according to the present embodiment is further wider than the roller according to the present technology. If the interval is too small, it is not beneficial to place the supporting rods 30. After the practical test, the interval between the rollers on the same rotating shaft is suitable in the range of 25˜150 mm.

The rollers used in the transporting device of glass substrate according to the present technology possess small width and larger interval. The vibration of the glass substrate will be occurred during transportation, resulting accuracy difference after transportation, which needs to precisely positioning through arranging mechanism. However, the width of the rollers used in the transporting device according to the present embodiment is increased, the contact area between the roller and the glass substrate is increased, and the material with higher buffer performance, which increases the friction between the roller and the glass substrate, so that the arranging mechanism can not push the glass substrate to position. Moreover, if force the arranging mechanism to proceed mechanical positioning, the glass substrate may be damaged due to larger friction. Therefore, the present embodiment does not use arranging mechanism to position, but controls the speed of the rollers and level coordination instead, which is more stable. The results after practical test show that the transportation of the glass substrate is stable without vibration and beating.

In the roller and the transporting device of the transporting glass substrate according to the present invention, the roller is widened, which is made of the material with better buffering performance. When it is used for transporting the glass substrate, the contact area between the roller and the glass substrate will be increased. And the distance between the rollers is decreased, so that the glass substrate will be transported steadily with average stress, and the structural damage of the substrate will be decreased, which avoids the mura problems and improves the level and quality of the glass substrate.

The disclosed embodiments are the preferred embodiments of the present invention, but not intending to impose any unduly constraint to the appended claims. Any equivalent change is considered encompassed in the scope of protection defined by the clams of the present invention.

What is claimed is:

1. A roller for transporting glass substrate, comprising: a cylindrical body and an outside layer coated on the side of the cylindrical body, the distance between the top and the bottom of the cylindrical body being 100˜120 mm, the cylindrical body being made of MC nylon, and the outside layer being polyurethane coating.

2. The roller as claimed in claim 1, wherein the axle of the cylindrical body is provided with an axle hole defined through the top and the bottom.

3. The roller as claimed in claim 1, wherein the thickness of the polyurethane coating is 5 mm.

4. A transporting device of glass substrate, comprising: at least two rotating shafts provided in parallel with an interval, each rotating shaft coaxially providing with two rollers, the roller further comprising: a cylindrical body and an outside layer coated on the side of the cylindrical body, the distance between the top and the bottom of the cylindrical body being 100˜120 mm, the cylindrical body being made of MC nylon, the outside layer being polyurethane coating; and a liftable platform provided below the rotating shaft and the roller.

5. The transporting device of glass substrate as claimed in claim 4, wherein the axle of the cylindrical body is provided with an axle hole defined through the top and the bottom.

6. The transporting device of glass substrate as claimed in claim 5, wherein the rotating shaft passes through the axle hole and is assembled with the roller through a set collar.

7. The transporting device of glass substrate as claimed in claim 4, wherein the interval between the rollers on the same rotating shaft is 25˜150 mm.

8. The transporting device of glass substrate as claimed in claim 4, wherein the liftable platform comprises multiple supporting rods which are provided at the interspace between the rotating shafts and between the rollers.

9. The transporting device of glass substrate as claimed in claim 8, wherein the multiple supporting rods are divided into multiple groups, the supporting rods of each group are provided between the adjacent rotating shafts, and the supporting rods of the same group are aligned with each other and arranged in a line.

10. The transporting device of glass substrate as claimed in claim 4, wherein the thickness of the polyurethane coating is 5 mm.

11. A transporting device of glass substrate, comprising: at least two rotating shafts provided in parallel with an interval, each rotating shaft coaxially providing with two rollers, the interval between the rollers on the same rotating shaft being 25˜150 mm, the roller further comprising: a cylindrical body and an outside layer coated on the side of the cylindrical body, the distance between the top and the bottom of the cylindrical body being 100˜120 mm, the cylindrical body being made of MC nylon, the outside layer being polyurethane coating; and a liftable platform provided below the rotating shaft and the roller.
